(19) United States
(12) Patent Application Publication
(10) Pub. No.: US 2021/0155457 A1
(43) Pub. Date: May 27, 2021

(54) ELEVATOR SYSTEM WITH MULTIPLE INDEPENDENT CARS IN A 2-DIMENSIONAL HOISTWAY

(71) Applicants: Man Hay PONG, Hong Kong (HK); Albert Ting Pat SO, Hong Kong (HK)

(72) Inventors: Man Hay PONG, Hong Kong (HK); Albert Ting Pat SO, Hong Kong (HK)

(73) Assignee: Man Hay Pong, Hong Kong (HK)

(21) Appl. No.: 16/695,221

(22) Filed: Nov. 26, 2019

(51) Int. Cl. B66B 9/00; B66B 11/04; B66B 1/30

(52) U.S. Cl. CPC B66B 9/003; B66B 2201/30; B66B 1/302; B66B 11/0469

(57) ABSTRACT

An elevator system contains a plurality of cars; a twin channel vertical hoistway, a first channel for ascending movement and a second descending movement; and a plurality of horizontal connecting passages between the twin channel vertical hoistway. Sprocket and wheel system mounted in vertical hoistway move cars vertically. Rotatable disc coupled to levers move cars in horizontal connecting passages. Electrical system coupling motors for vertical hoisways enables energy exchange between ascending and descending cars.

### BACKGROUND

In a multi story building, a conventional elevator system allows one car in one hoistway only. It is always desirable to put multiple cars in a hoistway especially for high-rise buildings so that less floor area is occupied by the elevator system. On the other hand, conventional elevator system with ropes is limited by the height of the building because of the weight of the ropes. Beyond a certain height, the ropes become so heavy that the elevator drive is inefficient to operate.

Prior work has been done with the common aim to put multiple cars in a hoistway. However, most are not practical to implement. A straight forward idea to put multiple cars in one hoistway is the double deck car. The inventor in U.S. Pat. No. 5,107,962 extends the application of double decker elevator cars. In a hoistway there is a double decker car which runs from the entrance of the building to a sky lobby where passengers can change to two smaller delivery cars. These delivery cars are placed above the main double decker car in the same hoistway so there are three cars in the hoistway. This method does not seem to be able to improve traffic significantly as the essence of this invention is to split the upper hoistway to accommodate two smaller delivery cars. In US patent application 20060016640 two cars are temporarily locked in as double deck cars. There are two transfer platforms for cars to move horizontally towards another hoistway, but this is likely to produce a traffic bottleneck. This arrangement requires extra floors as transfer zone. Inventors in U.S. Pat. No. 9,994,424; US patent applications 20150291390; 20130118837; 20090301818 all propose to put two cars in one hoistway using two separate rope systems. Obviously one car cannot go pass the other and there is danger of collision. Complicated methods are proposed to avoid collision. Due to the complicated roping arrangement, such design is limited to two cars within one hoistway only so traffic performance cannot be improved significantly.

In US patent application 20080149428 the inventor uses three elevators in a hoistway. Each car moves in an adjustable zone while there is at least one common transfer floor. After one elevator has moved up and taken passengers to the transfer floor, this elevator moves down and make room for another elevator to go to the transfer floor and picks up the passengers to continue the upward journey. Each car carries its own motor. Obviously, there is a problem in arranging the entangling power cables to the cars in order to feed the motors. Actually the inventor in U.S. Pat. No. 6,333,865 had made an attempt to solve the problem. The invention proposes a non-contact high frequency wireless charging by a controlled inverter. This is not practical because the motor in each car demands a lot of power but wireless charging has inherent low transfer efficiency and power level. In U.S. Pat. No. 5,857,545, the inventor proposes an elevator system with multiple hoistways while each hoistway has multiple vertical segments. Each segment has motor and counterweight systems. Multiple cars moving in one hoistway can move between segments by mechanically coupling to a counterweight. This invention has the drawback that movement of couplers needs an additional hoistway which takes up floor space. The counterweights often have to move unloaded up and down to fetch cars from segment to segment. This additional counterweight movement consumes extra energy. There are exchange platforms on which the cars come out of one hoistway and carried by trolleys to another hoistway. The trolley system requires additional floor space and complicated transportation system which adds to the cost of the system significantly.

Hitachi has presented a circulating elevator in patent EP1647513A3. It employs a complicated drive system and ropes connected to pairs of cars. A pair of cars are moved by a set of motors at the top of building. The horizontal movement of the Hitachi invention is served by a complicated belt & pulley system which occupies at least one floor space at the top and the basement. In this system, there can be one transition floor on the top and another one at the basement of the building only. Traffic of one car is affected by its counterweight partner in the adjacent hoistway. This has the same problem as that in a double deck lift while one car has to stop unnecessarily because of the other car. There is still a danger of collision in this system because car pairs are separately operated by different machines.

A Korean patent (KR20000033344A) presents a roped multi-path elevator system. Essentially this invention tries to achieve multiple car operation by having a special shaft structure in the building. Each shaft has a car frame which carries the car vertically. There are intersecting platforms on which the car is moved from one shaft to another whereby the car can continue its journey. This system requires a very special building structure which requires substantial changes from the current building structural design. On the other hand, this system requires the car frame to return to a bottom floor to pick up a new car after it has delivered its car to an adjacent shaft at the top floor. This redundant return journey carries no car but only to consume energy. So this system is not very energy efficient as half of its trips are redundant.

ThyssenKrupp presents a patent (US2017/0107080) which proposes a rotationally coupler which can move the car horizontally and vertically. There is a feature for oblique travel at an angle but such application is not needed in the market today. Like all self-propelled elevator cars they are not collision free. Sophisticated sensors and central control are critical to ensure safe operation. This system employs linear motor in each car which interacts with a long stretch of stator on the rail. Inherently accurate positioning by a linear motor is very difficult and expensive because the car is essentially floating in air, but accurate positioning is an essential elevator feature to avoid passengers tripping over when moving in and out of the car. Power delivery to the motor on board is also an issue. Relatively high power is needed and power delivery to a moving car needs expensive equipment. So linear motor in car presents obvious drawbacks.

Toshiba has presented a self-propelled multi-car elevator system (JP 2006225052). It requires an extra platform on each floor to harbor the car during loading and unloading. The extrusion platforms take up valuable floor area. There is also a mechanism to change vertical movement to horizontal movement by rotating rollers rolling on rails. Still, collision cannot be eliminated in the vertical hoistway. This invention requires each car to be powered by linear motor which has problems mentioned.

Elevator safety in high-rise buildings is always a focal point. Since the invention of the elevator safety device by Otis in the 19th century there has been a lot of development but nearly all such developments were designed for roped elevator systems only. An elevator safety device comprises of braking mechanism which makes use of centrifugal force. When the car has exceeded a safety vertical speed, the mechanism brakes and stops the car. However, for autonomous ropeless elevator cars with horizontal as well as vertical movement, there must be a new device safety device.

In a conventional elevator system, there is a counterweight which offsets the weight of the car. With the counterweight, the lifting effort or energy is reduced to the work done on the difference in tension between the car side and the counterweight side. In a system with multiple cars running in one hoistway, the use of the conventional counterweight system is not possible and a new method is required.

### SUMMARY

As described herein, this is a new elevator system with horizontal car movement.

It is an aspect of this invention to put. multiple cars into one elevator hoistway to increase traffic flow and reduce floor area occupied by the elevator system in multi-story buildings.

It is an aspect of this invention to have cars with no rope attachment so that the elevator can go all the way through the height of a tall building without the involvement of heavy ropes.

It is an aspect of this invention to have circulation movement of elevator cars in a building with horizontal movement through multiple passages.

It is an aspect of this invention to adopt current vertical hoistway structure without the need to seek approval for a new building structure. This feature is in particular beneficial to modernization and renovation of existing buildings.

It is an aspect of this invention to enable each car to move autonomously without being affected by another, in general.

It is an aspect of this invention to make the system free from car collision, in general.

It is an aspect of this invention that each car needs not carry the propulsion motor to achieve a light weight and avoid complicated power delivery equipment.

It is an aspect of this invention to have a safety device which prevents a car from free falling under all circumstances.

It is an aspect of this invention to make a multi-car system work like the conventional counterweight system which takes advantage of the energy exchange among cars that go up and down.

It is an aspect of this intention to eliminate electrical cable connection to the cars so that the movement of the car is free from entangling cables while in-car power is maintained.

### BRIEF DESCRIPTION OF THE DRAWINGS

FIG. 1 illustrates an embodiment of a circulating elevator system with multiple horizontal passages.

FIG. 2 illustrates an embodiment of an elevator car equipped with vertical and horizontal movement apparatus.

FIG. 3 illustrates an embodiment of mechanisms to move a car in the vertical direction.

FIGS. 4a and 4b illustrates an embodiment of showing the details of the sprocket and chain set and coupling mechanism to the car.

FIG. 5 illustrates an embodiment of a horizontal passage and its associated apparatus.

FIG. 6 illustrates an embodiment of the horizontal shifter apparatus.

FIGS. 7a and 7b illustrate an embodiment of extended (7a) and retracted (7b) states of the horizontal shifter gear.

FIG. 8 illustrates an embodiment of a grabber brake.

FIGS. 9a and 9b illustrates an embodiment of a governor wheel (9a) and wedge typed safety gear (9b).

FIG. 10 illustrates an embodiment of an electronic counterweight system for energy exchange between cars going down and those going up.

FIG. 11 illustrates an embodiment of on board battery and battery charger at the guide rails in the horizontal passage.

### DETAILED DESCRIPTION

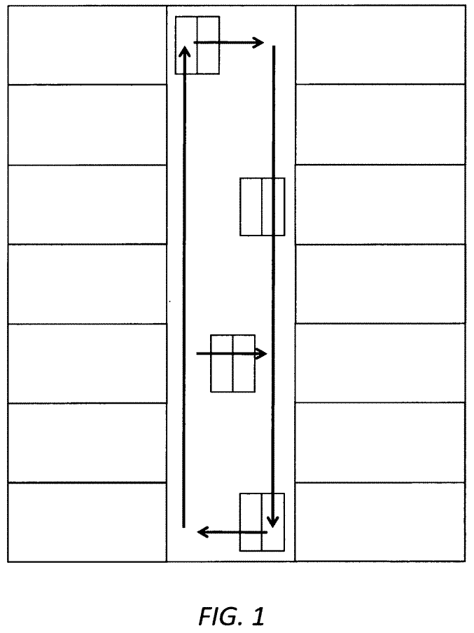

The operation of the present invention is described herein. FIG. 1 illustrates a circulating elevator system comprising of two hoistways with multiple cars moving in a single direction in each hoistway. The elevator system can accommodate not only multiple elevator cars within the system, but also multiple elevator cars in one vertical hoistway (such as multiple elevator cars in an ascending hoistway and/or multiple elevator cars in a descending hoistway).

There are at least two vertical hoistways connected by multiple horizontal passages whereby cars move upward in one hoistway and downward in another one. There are at least two horizontal passages, one at the top of the two vertical hoistways and one at the bottom of the two vertical hoistways. In one embodiment as an example, the elevator system contains at least three horizontal passages connecting the two vertical hoistways, one at the top of the two vertical hoistways, one somewhere mid-level vertically between the two vertical hoistways, and one at the bottom of the two vertical hoistways. In another embodiment, the elevator system contains at least four horizontal passages connecting the two vertical hoistways, one at the top of the two vertical hoistways, two somewhere mid-level vertically (but separated from each other) between the two vertical hoistways, and one at the bottom of the two vertical hoistways.

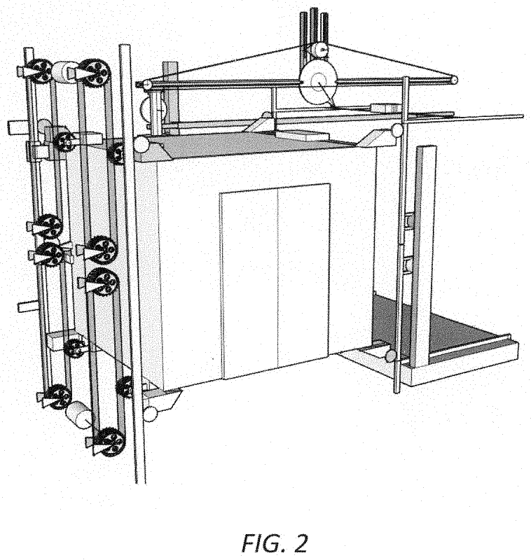

Elevator cars can move horizontally through multiple horizontal passages located on different floors of the building. There should at least be one horizontal passage on the bottom floor and another one on the top floor but there can be additional horizontal passages to cater for different traffic conditions in tall buildings. In this system elevator cars can move independent of one another and a typical elevator car of the present invention is shown in FIG. 2. While the car is capable of moving vertically and horizontally, it carries no motor so the car is light weighted. It depends on external mechanisms to move vertically and horizontally.

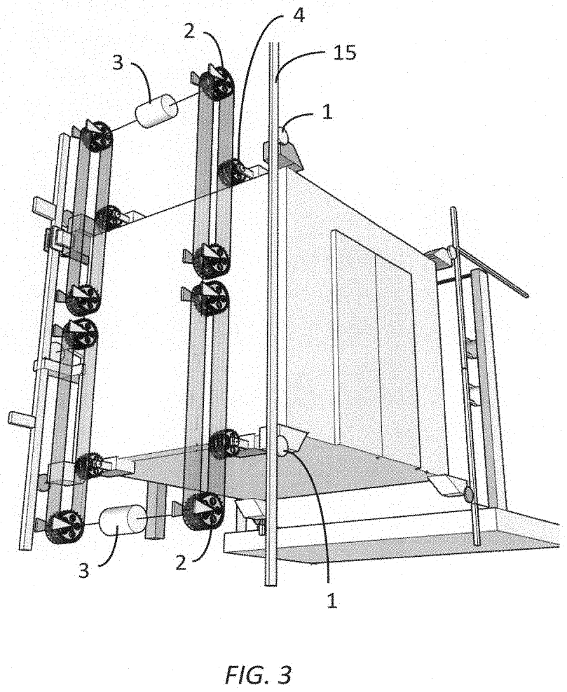

Apparatus to move a car up or down is shown in FIG. 3. The elevator car resides in the hoistway with roller wheels (1) resting on guide rails (15) so that the car is secured to move in either up or down direction only, without swinging and vibration. Note that the guide rail (15) is a continuous rail while FIG. 3 shows a cut away version for simplicity. There are altogether eight roller wheels at the eight corners of the cubical car. Mechanisms to move the car vertically comprises of sections of sprockets and chains (2) whereby each section having two parallel sprocket and chain sets is propelled by a motor (3) coupled to the sprocket sets. Such sprocket and chain sets are installed on one side of the hoistway. Titling of the car is prevented by the said eight roller wheels resting on guide rails. On the car there is a locked sprocket set (4). When it is coupled to the moving chain the car is moved up or down vertically. More details are described in the next paragraph. Each sprocket and chain section (2) may extend over tens of floors in a building, thus forming one physical section of the drive system. The schematic diagram shows a short section of the set only for simplicity and clarity. This arrangement in a building has multiple vertical sections to drive cars up and down, while the length of sections may be different depending on traffic design. The hoistway is now free to build to any height without the need to accommodate heavy long ropes throughout the height of the building.

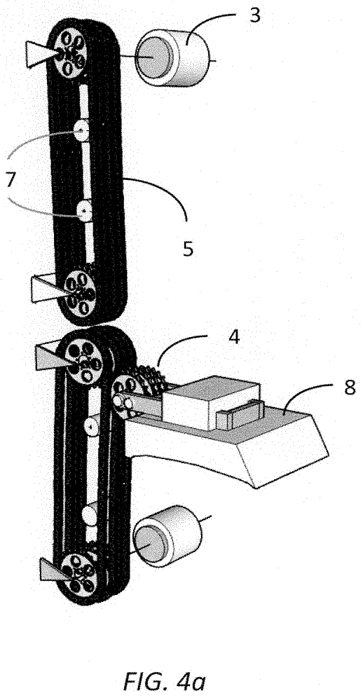

Details of the sprocket-chain set are shown in FIGS. 4a and 4b. Each sprocket-chain section is powered by a motor (3) at one terminal and different sections may drive its own cars independently. The other terminal of the section is equipped with a sprocket pulley for return and tensioning of the chains. The motor (3) is coupled to a sprocket set and drives a plurality of chains (5) which rest against rollers (7). Another sprocket set (4) fixed to the car body (8), called the on-car sprocket set, comes into contact with the chain whereby vertical motion is propelled by the motor and chain. FIG. 4b shows details of the sprocket (4) fixed onto the elevator car body (8). There is a set of springs (9) to ensure good contact between the sprocket and the chain. When a car crosses over from one section to another, the two sections must be synchronized to the same speed first. Sprocket sets are fixed at the four corners of the same side of the car. When one pair of the sprockets, say the upper pair, rides through to another chain set, the car is being pushed up by the lower sprocket pair so that the car can move smoothly across at constant speed. There is further pin and lock mechanism (14) which locks the rotation of on-car sprocket set (4). Normally, the sprocket set (4) is locked so that the elevator car can be moved up or down by the chain set. The motor drive of each sprocket-chain set is equipped with a brake itself so that the car is indirectly braked when the pin and lock mechanism is active. However, there may be circumstances in which the lock is released. Such cases include emergency operation while the car is secured by other means such as brakes in the car.

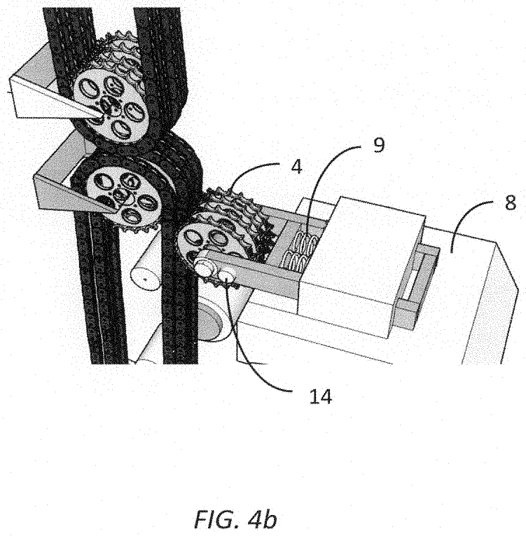

The elevator car moves through horizontal passages in the building to complete the circulating loop. The horizontal passage and its associated apparatus are shown in FIG. 5. At the entrance to the horizontal passage, the elevator car stops. There is an extension support (12) which moves out to support the car in association with a set of horizontal shifter mechanism (13). Note that there is reciprocal horizontal shifter mechanism (13) extended across both sides of the horizontal passage. For simplicity and clarity, only the left hand side of the mechanism is shown in FIG. 5. Once the extension support (12) is fully extended and secures the car, movable vertical guide rails (11) are rotated out of the way so that the elevator car can move into the horizontal passage. The car is then moved smoothly on horizontal guide rails (10) in the horizontal passage by the mechanism described in the next paragraph.

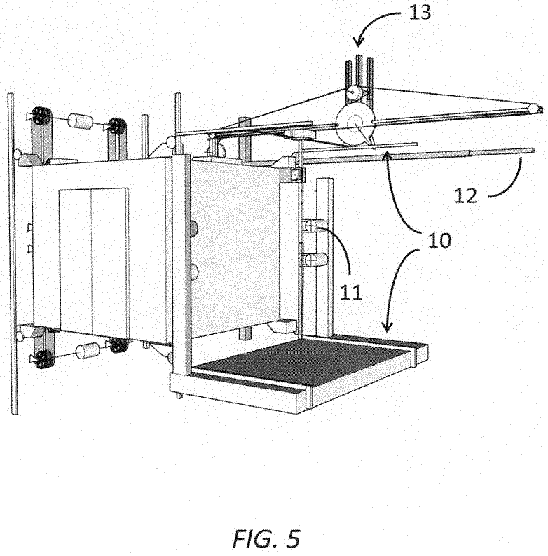

Details of the horizontal shifter apparatus is shown in FIG. 6. It comprises of apparatus having extension support (12) on both sides. In case when the elevator car (8) moves through vertically without going into the horizontal passage, this extension support is retracted to allow the elevator car to pass through freely. When the elevator car needs to move horizontally it stops in position by applying its brakes. The extender (12) then extends and catches under a roller (21) mounted on the elevator car body (8). The elevator car is then secured from falling vertically. At the same time, when the horizontal extender (12) is being extended, a pulley (20) carrying a long chain (24) is also extended simultaneously to reach an elevator car support which holds the elevator car roller (21). On top of this roller support there are spur gears which couple to the chain (24). A motor (23) in the mechanism rotates in the anticlockwise direction so that the chain having coupled to the elevator car support moves the elevator car horizontally to the right hand side. The roller (21) rests on the extension support (12) and go all the way along the horizontal passage. The car moves horizontally under the traction of the chain (24) powered by motor (23) until the car reaches the other end of the horizontal passage. Now the car has arrived at the adjacent vertical hoistway and has moved horizontally from one hoistway to the other. There can be a symmetrical set of the apparatus mounted on the opposite side of the horizontal passage to provide balanced traction for the horizontal movement of the car.

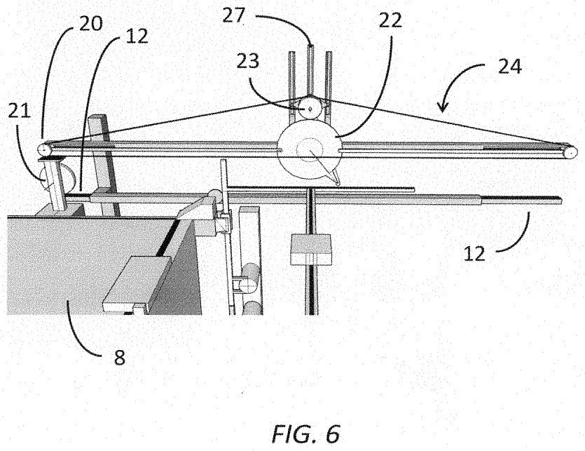

The extension and retraction mechanism of the horizontal shifter gear and its associated apparatus is shown in FIGS. 7 a and b. The apparatus comprises of pulleys (20) at the two ends of the apparatus. A chain (24) runs along these two pulleys and is powered by motor (23) which moves the elevator car horizontally. The motor (23) itself slides on vertical guideways (27 in FIG. 6) up and down vertically. This vertical movement is created by a lever (26) which is mounted on a rotating disc (22) powered by another motor. This rotating disc is further coupled to two levers (25) which further couple to the pulleys (20) at the ends of the apparatus. FIG. 7a shows the apparatus in the extended state. The disc (22) is rotated in such a manner that levers (25) are fully extended and motor (23) is pulled down. FIG. 7 b shows the retracted state. The disc (22) is rotated in a manner such that the levers (25) together with the pulleys (20) are retracted. Motor (23) is pushed upwards along guideways in order to accommodate the length of the chain.

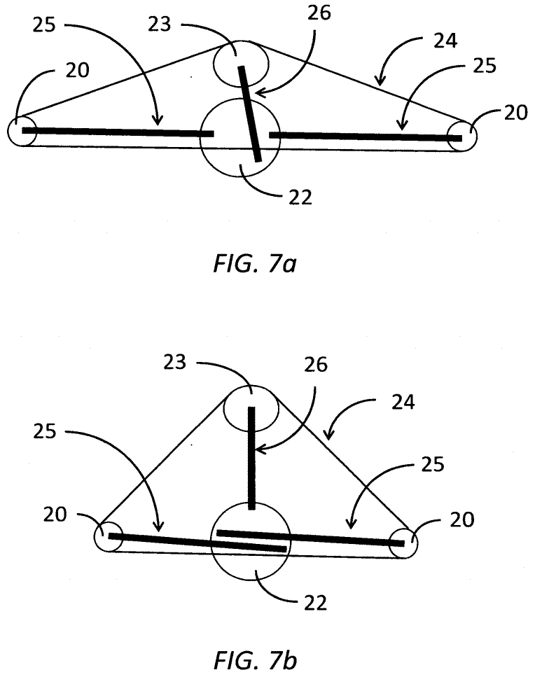

Although the elevator car is propelled by the vertical chain set which can be braked at its drive motor, there is a braking mechanism on board for security and versatile operation. FIG. 8 shows a grabber brake mounted on the car body (8). It comprises of a pair of brake pads (30) which grab onto the guide rail (15) when the brake is applied, while the roller wheel runs on the guide rail The brake is of a “fail-safe” design which is electrically released by a solenoid and mechanically applied by spring. If there is a loss of power or controller failure the brake will clamp on the guide rail automatically. A good redundant design is to have such grabber brakes installed at the four upper corners of the elevator car, two on each side, where the car rollers rest against the guide rails. For fail safe design when there is a power failure in the car the brake is applied. Normally, when the car is moving, the brake is kept off or opened by an electric solenoid.

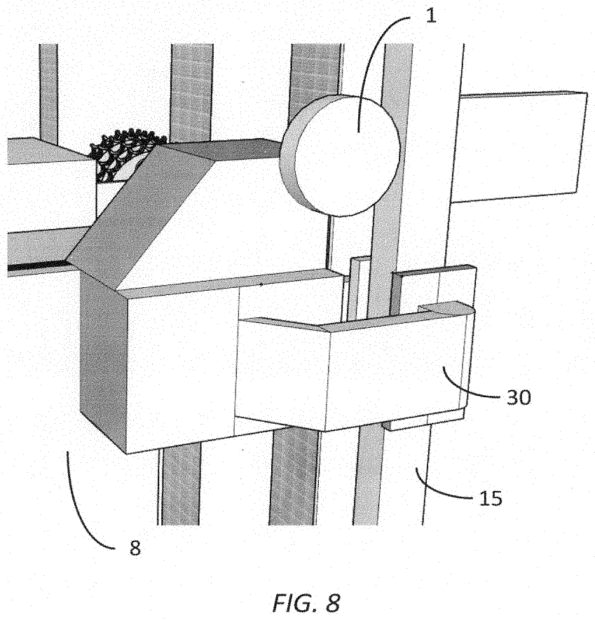

The elevator car must be protected against free fall in the event of power system failure, or even when the sprocket and chain sets are broken apart. FIGS. 9 shows a safety gear that is mechanical in nature and does not depend on any external power. Even in the case of vertical chain breakage and power failure this mechanical safety gear can still safety stop the car from falling vertically. Four sets of such safety gears are mounted at the top or bottom of the elevator car at the four corners as redundant design. FIG. 9a shows a cut away view of the safety gear system comprising a centrifugal speed governor (31) which is a popular device in the conventional elevator system. In a conventional roped elevator system, this speed governor is mounted on the top of the hoistway and linked to the elevator car by a governor rope. In the present invention this speed governor is mounted on board the elevator car and is brought in contact with the guide rail (15) so that the speed governor directly detects the speed of the moving car. The speed governor comprises of a set of flyweights (32) secured by springs in normal runs. If the speed of the car exceeds the speed limit the flyweights are driven outward due to centrifugal force and engage onto a set of tooth gear (33). FIG. 9b shows the safety gear from another view. The gear (33) is coupled to a disc with a belt (34). When engaged the belt triggers wedge shaped pads (35) which clamp onto the guide rails (15) and stop the car. In more details the belt (34) pulls up a lever (36 in FIG. 9a) and press the pads against the guide rail. The braking effect is self-enhancing, as the further the car moves downwards, the harder the wedge brake presses against the guide rail. Once the speed governor is triggered, a lever (37) and axis (38) trigger on the safety gears at the other three corners of the car so that all four safety gears operate at the same time to bring the decending car to an emergency stop.

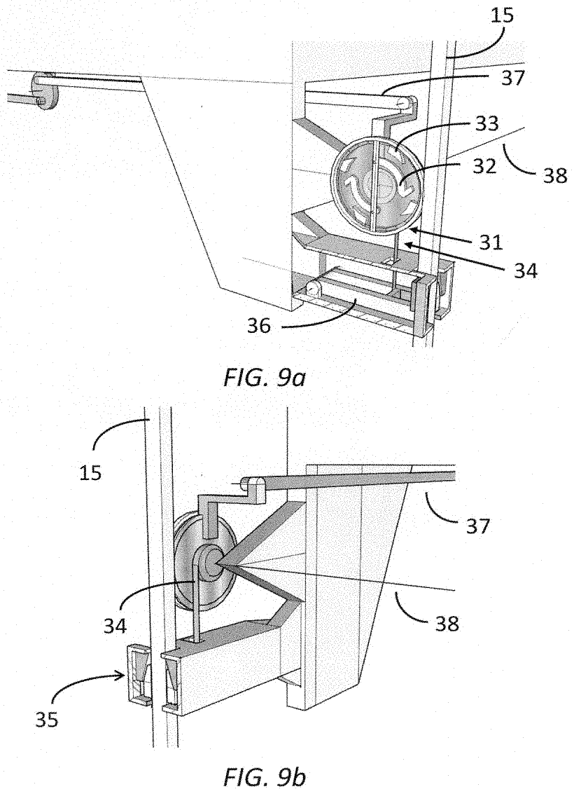

The disclosure herein involves multiple cars operating in one hoistway which cannot adopt a conventional counterweight system with hoisting ropes. In order to provide similar energy saving measures an “electronic counterweight” system is presented in FIG. 10 which allows energy exchange between cars going down and those going up. The system comprises of power inverters (40, 41) coupled to all electric drives of the sprocket-and-chain sets. All the power inverters are coupled to a DC bus (42). Electrical drives which drive cars upward (45) consume energy while those drive cars download (46) generate electricity. The DC bus allows energy exchange between drives. As cars move in a circular manner, energy generated by cars going down are transferred to those going up. AC to DC converter (43) connected to the mains supply only provides energy difference which can greatly reduce overall energy consumption. While cars going up and down may not be synchronized all the time, storage apparatus (44) coupled to the DC bus provides an energy buffer. The storage apparatus can be a battery set or mechanical flywheel or any other suitable energy storage apparatus.

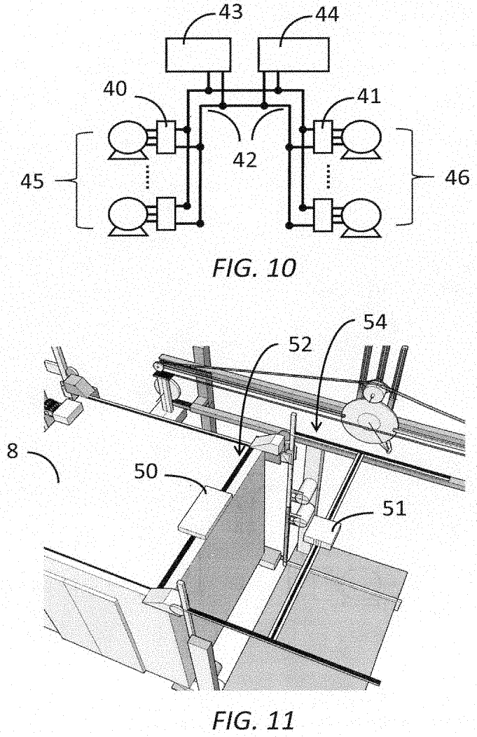

In the multiple car system, power delivery to the moving cars is an issue. However, this issue is solved by the fact that individual car does not need high propulsion power and only relatively low power is needed for lighting, ventilation, control, operation of the on-car brake, the pin-and-lock mechanism of the on-car sprockets and the car doors. Here in this invention, a method to deliver electrical power to a car through the horizontal passage is presented. FIG. 11 shows an electrical delivery system for battery charging. It comprises of an on board battery (50) which serves the needs of the car. The two battery terminals (52) are connected to roller wheels on the sides of the car respectively. When the car moves through the horizontal passage, the wheels come into contact with the horizontal guide rails (54). The guide rails are connected to a battery charger (51) which is a fixed installation and the battery can be charged up during the transit through the horizontal passage. As the power required by the car is low the battery charger can deliver power at low voltage so there is no danger of electric shock even when the guardrails are exposed. The battery and charger are designed so that this transit charging is able to keep the battery full. This new arrangement has the advantage that power in car is independent of the mains supply. In case there is a power failure at the mains supply, power is still available in the car so that the car can still operate the brakes, sprocket pin-lock and door mechanism. There can be power failure emergency procedures to evacuate passenger automatically. This eliminates passengers trapped in elevator car due to power failure.

The embodiments described herein are illustrative but not restrictive, all variations within the scope or come within the meaning of the invention as indicated by the description and claims are intended to be embraced by this patent.

What is claimed is:

1. An elevator system comprising
a plurality of cars;
a twin channel vertical hoistway, a first channel for ascending movement and a second channel for descending movement;
a plurality of horizontal connecting passages between the first and second channels; and
a motorized chain system in cooperation with a sprocket-wheel device for vertical movement of the cars.

2. The elevator system according to claim 1, wherein the sprocket-wheel device on the elevator car is releasable and lockable for coupled vertical movement.

3. The elevator system according to claim 1, wherein the sprocket-wheel device on the elevator car is releasable and retractable for horizontal movement.

4. The elevator system according to claim 1, further comprising:
a horizontal movement system for moving a car through the horizontal connecting passages comprising:
two levers each coupled to a rotatable disc for extending and retracting the two levers;
two pulleys each at an end of the two levers, respectively, opposite the rotatable disc; and
an endless chain running around the two pulleys configured to engage the car.

5. The elevator system according to claim 4, the horizontal movement system further comprises:
a first motor configured to move the chain,
a second motor to extend the two levers, and retract the two levers.

6. The elevator system according to claim 4, wherein the horizontal movement system engages the car when the two levers are in an extended state.

7. The elevator system according to claim 4, the horizontal movement system comprising a plurality of rotatory guide rails which rotate and make way for an elevator car to pass through the horizontal passage.

8. The elevator system according to claim 1 comprising at least three horizontal connecting passages between the first and second channels.

9. The elevator system according to claim 1 comprising at least four horizontal connecting passages between the first and second channels.

10. The elevator system according to claim 1, wherein the first channel for ascending movement comprises at least two cars.

11. The elevator system according to claim 1, wherein the second channel for descending movement comprises at least two cars.

12. The elevator system according to claim 1, wherein each elevator car carries a speed governor which triggers a brake configured to stop the car from falling.

13. The elevator system according to claim 1, wherein each elevator car contains a battery, a plurality of electrical conductors which come into contact with other electrical conductors in the horizontal passage and charge up the battery when the car passes through the horizontal passage.

14. The elevator system according to claim 1, wherein electrical circuits of said motorized system for vertical movement of cars are coupled together so that cars in descending movement may deliver their electrical energy to those cars in ascending movement.
